(19) United States
(12) Patent Application Publication
(10) Pub. No.: US 2016/0205163 A1
(43) Pub. Date: Jul. 14, 2016

(54) System And Method For Curating Digital Content From A Digital Content Platform

(71) Applicant: Ronak Patel, Princeton, NJ (US)

(72) Inventor: Ronak Patel, Princeton, NJ (US)

(21) Appl. No.: 14/991,142

(22) Filed: Jan. 8, 2016

Related U.S. Application Data
(60) Provisional application No. 62/102,176, filed on Jan. 12, 2015.

(51) Int. Cl. H04L 29/06; H04L 29/08

(52) U.S. Cl. CPC H04L 65/604; H04L 67/02

(57) ABSTRACT

A system and method for curating digital content from a digital content platform is disclosed herein. In some embodiments, the method for curating digital content comprises electronically receiving registration information to register a user therewith, as well as digital content platform account credentials for a digital content platform account of a digital content platform. The digital content curation system then transmits a request for access to digital content platform account data, along with the digital content platform account credentials. The digital content curation system then electronically automatically monitors digital content platform account data for an extraction marker of an extraction tag. Once detected, the digital content curation system extracts parent digital content indicated by the extraction marker of marked digital content and adds the extracted parent digital content to a collection identified using the extraction tag.

### CROSS-REFERENCED TO RELATED APPLICATION

This application claims the benefit of priority to U.S. Provisional Patent Application No. 62/102,176, filed on Jan. 12, 2015, the contents of which are incorporated herein by reference in their entirety for all purposes.

### BACKGROUND

1. Field of the Disclosure

The present disclosure relates to a system and method for curating digital content from a digital content platform, e.g., website. More specifically, the present disclosure relates to digital content curation from a digital content platform, e.g., a website, without having to leave said platform, e.g., the website.

2. Background

A number of different products are available that cater to the demand for curation of digital content. However, many of these products require curation from the software platform itself. As an example, for some products, if a user is logged into a social network through a web browser and comes across a post the user would like to add to his/her collection or feed, the user leaves the webpage and logs into the desired platform (e.g., Storify or TweetDeck) to add the post to his/her feed. Such a design can be cumbersome and time consuming for users.

FIGS. 1-5 are prior art products for curating digital content. FIGS. 1-2 illustrate the Storify platform 10 of the prior art for curating digital content. More specifically, FIG. 1 illustrates the Storify platform 10 of the prior art when creating or editing a collection of curated digital content. The Storify platform 10 comprises a supply content portion 12 and a curated content portion 14 for each Storify collection created and/or edited. The supply content portion 12 includes a network selection bar 16 displaying various network icons (e.g., Twitter 18a, Google+ 18b, Instagram 18c, etc.) to select. Once a network icon 18a-18c of the network selection bar 16 is selected, a user can search (via the search bar 20) for digital content within the network selected. The supply content 22a-22e which results from the search is populated in the supply content portion 12 of the platform 10.

The Storify platform 10 could include one or more Storify collections 30 of curated content 26a-26b. Each Storify collection 30 has a title 24 which can be entered (for newly created Storify collections) and/or edited (for previously created Storify collections) by a user. A user creates curated content 26a-26b by adding one or more supply contents 22a-22e to a selected Storify collection 30, such as by dragging and dropping a supply content 22a-22e from the supply content portion 12 to the curated content portion 14 of the Storify platform 10. Once the curated content 26a-26b has been added to the Storify collection 30, a user can publish the Storify collection 30 for public access (e.g., posting to a website, embedding in a website, etc.) by selecting the publish button 28. However, as shown in FIG. 2, to edit or update a Storify collection 30 of the prior art, a user returns to and enters the Storify platform, selects the edit button 32, and repeats the process described above.

FIGS. 3-5 illustrate the TweetDeck platform 50 of the prior art for curating digital content. More specifically, FIG. 3 illustrates the TweetDeck platform 50 of the prior art when creating or editing a custom TweetDeck timeline. The TweetDeck platform 50 comprises a toolbar 52 and one or more TweetDeck timelines 54a-54b. One type of timeline available is a custom timeline 56 composed of curated digital content. The curated digital content of the custom timeline 56 is compiled from one or more of the other TweetDeck timelines 54a-54b. One way to curate content into the custom timeline 56, as shown in FIG. 4, is to drag and drop digital content 62a (e.g., Tweet or post) into the custom timeline 56. Another way, as shown in FIG. 5, is to click on the digital content 62b-62c for a more action menu 64, and select Add to custom timeline to display a custom timeline submenu 66. A user can then select one or more of the custom timelines 68 from the custom timeline submenu 66 to add the content thereto. Once added the custom timeline can be shared on Twitter or embedded into other webpages. To edit or update the custom timeline 56, a user returns to the TweetDeck platform 50, and then repeats the process described above.

### SUMMARY

A system and method for curating digital content from a digital content platform, e.g., a website is disclosed. The digital content curation system allows a user to curate digital content from, for example, a website such as a third party website without having to leave the website to do so. The digital content curation system monitors (e.g., polls) the digital content platform, e.g., the website, for digital content created by a linked website account (e.g., via a mobile device of a user) that uses an extraction marker. The digital content curation system extracts the corresponding desired digital content and places it in the collection identified with the extraction marker. Accordingly, the digital content curation system allows a user to update and/or create collections of digital content from, for example, a website (e.g., Twitter), without having to leave the website (e.g., Twitter). The present disclosure is applicable to websites and other digital content platforms, and it shall be understood that a disclosure herein with respect to a “website” is also more generally a disclosure with respect to a digital content platform.

### BRIEF DESCRIPTION OF THE DRAWINGS

The foregoing features of the disclosure will be apparent from the following Detailed Description, taken in connection with the accompanying drawings, in which:

FIG. 1 illustrates a Storify platform of the prior art when creating or editing a collection of curated digital content;

FIG. 2 illustrates editing or updating a Storify collection of the prior art;

FIG. 3 illustrates a TweetDeck platform of the prior art when creating or editing a custom TweetDeck timeline;

FIG. 4 illustrates curating digital content into a TweetDeck custom timeline of the prior art by dragging and dropping;

FIG. 5 illustrates curating digital content into a TweetDeck custom timeline of the prior art by use of a menu and submenu;

FIG. 6 is a diagram showing a computer system on which the present disclosure could be implemented;

FIG. 7 is a diagram showing hardware and software components of a computer system on which the present disclosure could be implemented;

FIG. 8 illustrates processing steps of the digital content curation system of the present disclosure;

FIG. 9 is a diagram further illustrating the digital content curation system;

FIG. 10 is a screenshot of a sign-in page of the digital content curation system;

FIG. 11 is a screenshot of an application with digital content to be curated;

FIG. 12 is a screenshot of different collections associated with a particular user account of the digital content curation system;

FIG. 13 is a screenshot of digital contents stored in a particular collection;

FIG. 14 is a screenshot of a webpage of one of the collections created by a user;

FIG. 15 is a screenshot of a first digital content and a second digital content on a website;

FIG. 16 is a screenshot of a user reply to the first digital content which the user would like to curate;

FIG. 17 is a screenshot of collections associated with a user ID of the digital content curation system;

FIG. 18 is a screenshot of extracted digital content associated with a collection title; and

FIG. 19 is a screenshot of a webpage of a collection created by a user.

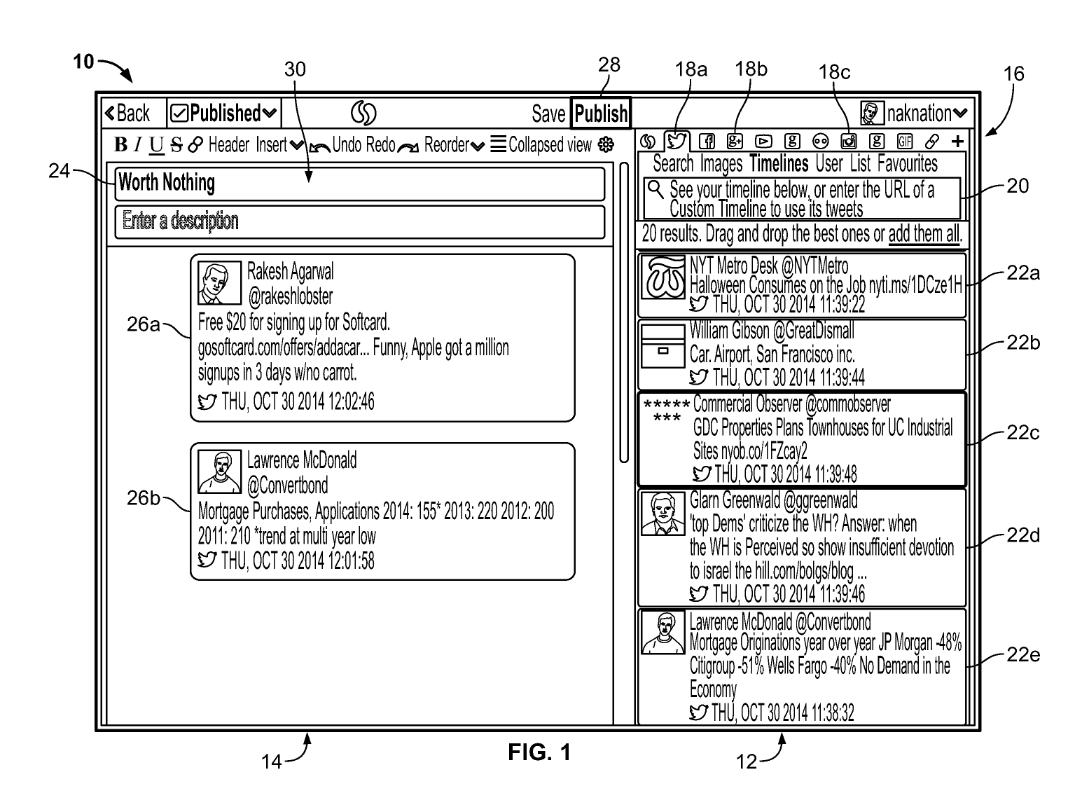

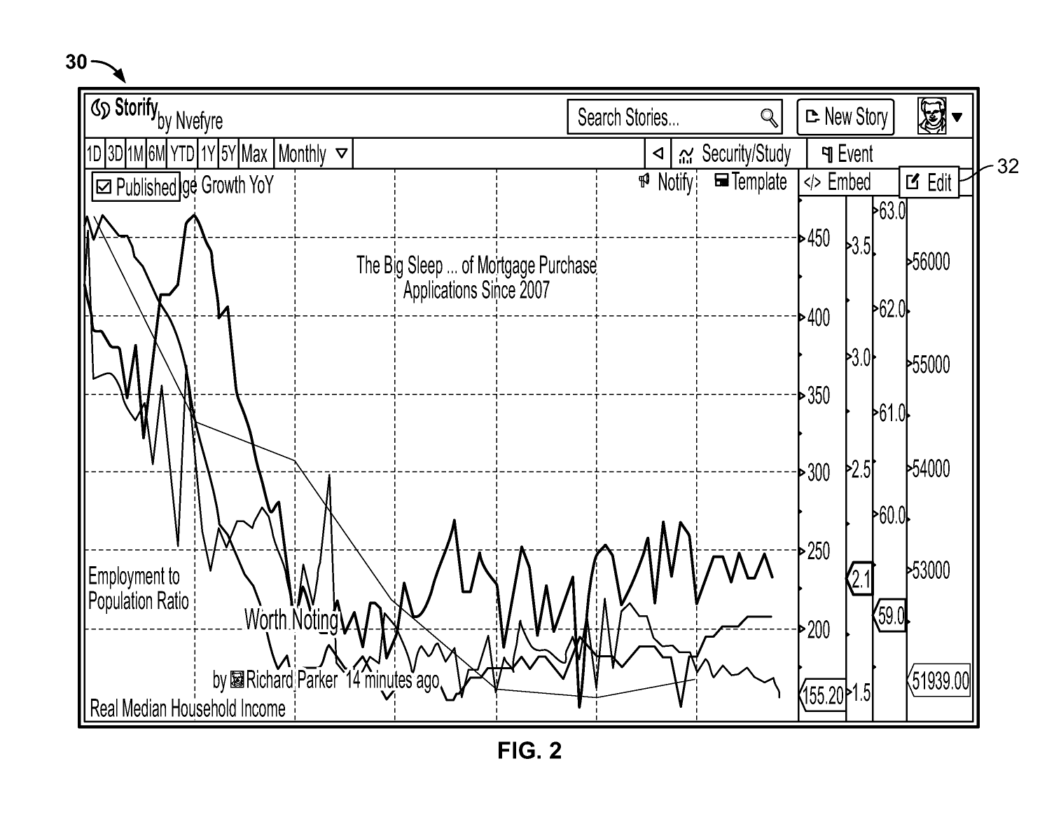

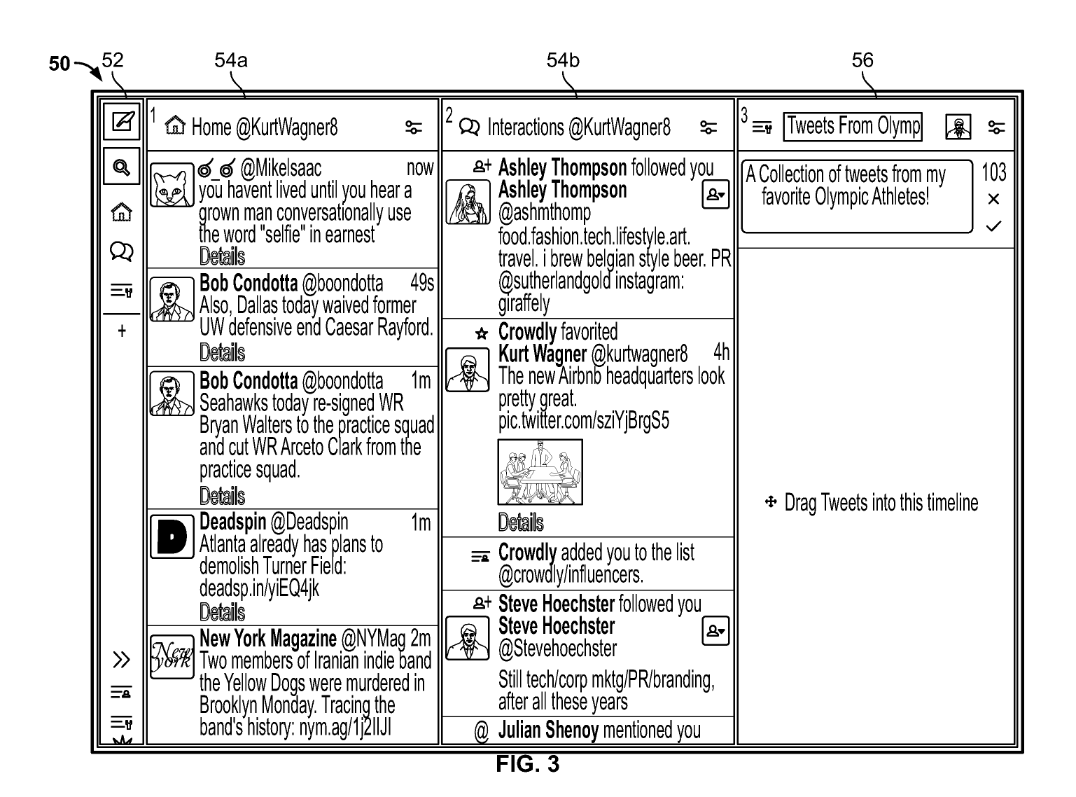

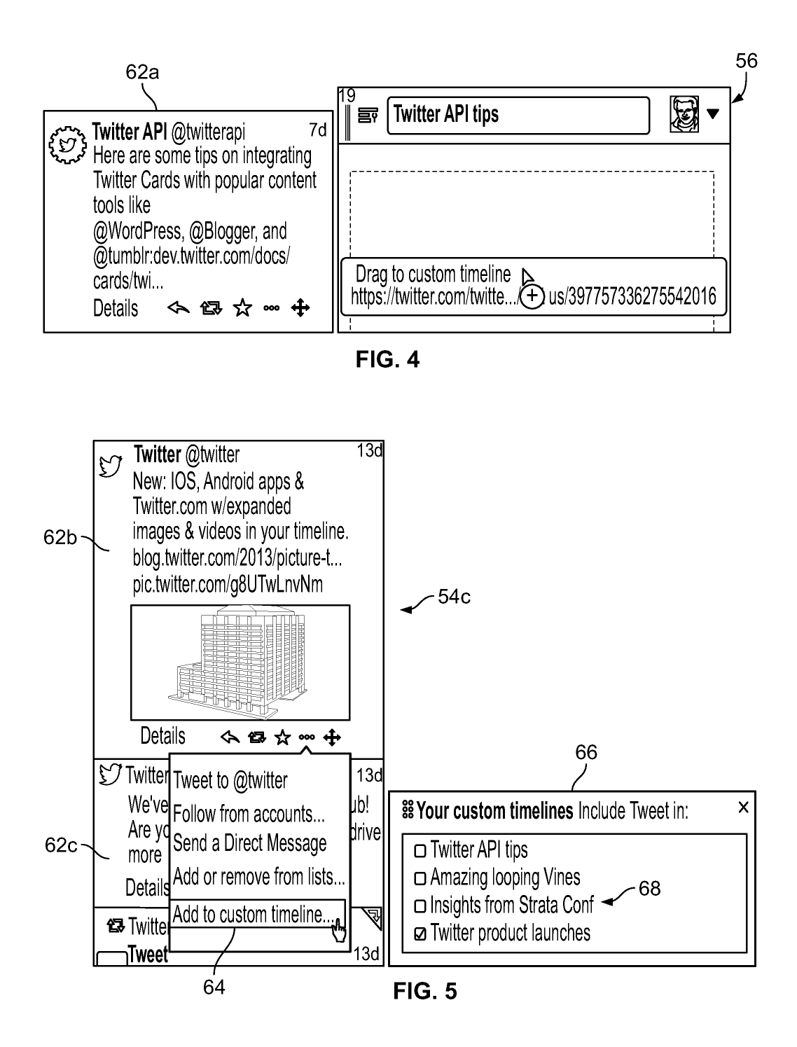

### DETAILED DESCRIPTION

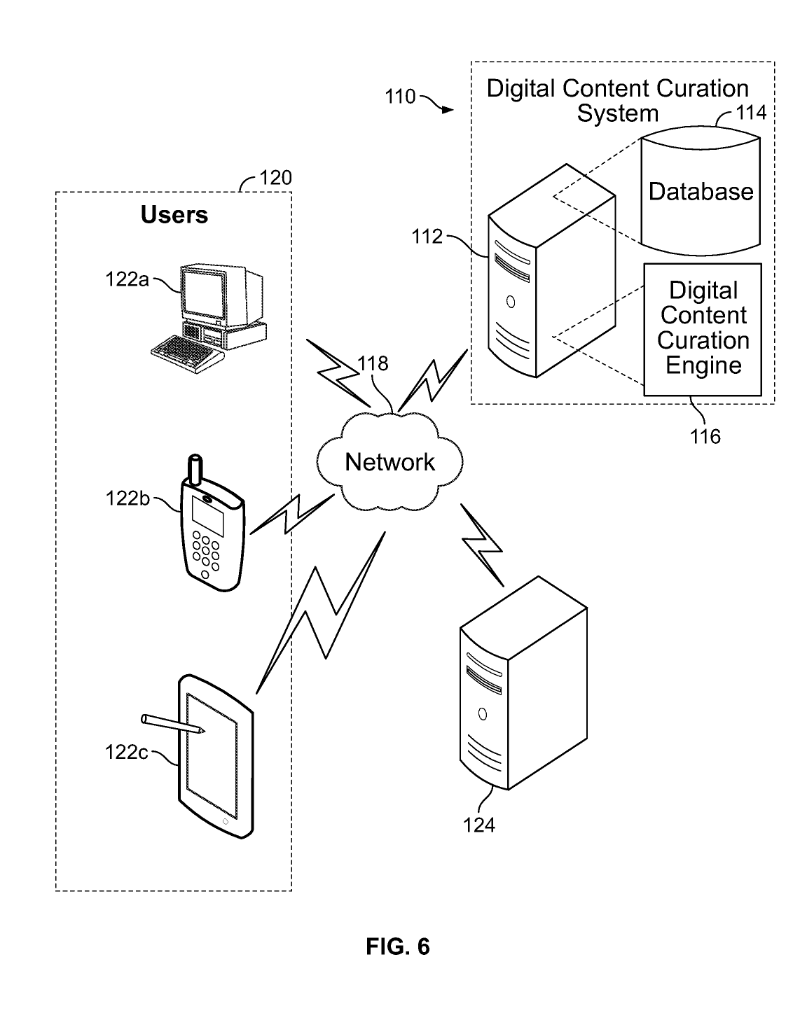

The present disclosure relates to a system and method for curating digital content, as discussed in detail below in connection with FIGS. 6-19. The digital content curation system (e.g., website, open source web application, smartphone app, tablet app, etc.) and method of the present disclosure facilitates curation of digital content (e.g., social media content) from a digital content platform, e.g., a website, without a user having to leave said platform, e.g., the website. In other words, the digital content curation system of the present disclosure provides the ability for content curation of digital content of, for example, a website from that website.

Using the digital content curation system of the present disclosure, when a user comes across digital content (e.g., Tweet, post, etc.) when browsing, e.g., a website, that the user would like to bookmark, share, or extract, the user simply replies to the digital content using an extraction tag, which includes an extraction marker and collection title. In other words, from a website account registered with the digital content curation system, for example, a user simply types the extraction tag (e.g., extraction marker and collection title) from any computing device (e.g., computer, mobile device, tablet computer, etc.) to direct the digital content curation system to extract associated digital content from, e.g., the website associated with the website account. In this way, the user can curate a tweet from Twitter, whether from a computer web browser, a mobile web browser, a mobile app, etc.

FIG. 6 is a diagram showing a computer system on which the present disclosure could be implemented. The digital content curation system indicated generally at 110, facilitates curating (e.g., managing, editing, updating, etc.) digital content (e.g., posts, tweets, etc.) The digital content curation system 110 comprises a computer system 112 (e.g., a server) having a database 114 stored therein and a digital content curation engine 116. The computer system 112 could be any suitable computer server (e.g., a server with an INTEL microprocessor, multiple processors, multiple processing cores) running any suitable operating system (e.g., Windows by Microsoft, Linux, etc.). The database 114 could be stored on the computer system 112, or located externally (e.g., in a separate database server in communication with the computer system 112).

The digital content curation system 110 is web-based, for example, and can be remotely accessible such that the digital content curation system 110 communicates through a network 118 with one or more users over a variety of computer systems 120 (e.g., personal computer system 122a, a smart cellular telephone 122b, a tablet computer 122c, or other devices). Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format. Further, the digital content curation system 110 could communicate with one or more servers 124 hosting one or more websites (and/or other digital content platform(s)) which have one or more user accounts registered with the digital content curation system 110. For example, the digital content curation system 110 could communicate with a social networking website (e.g., Twitter, Facebook, Google+, etc.), and/or any website which enables comment posting by users (e.g., registered or unregistered).

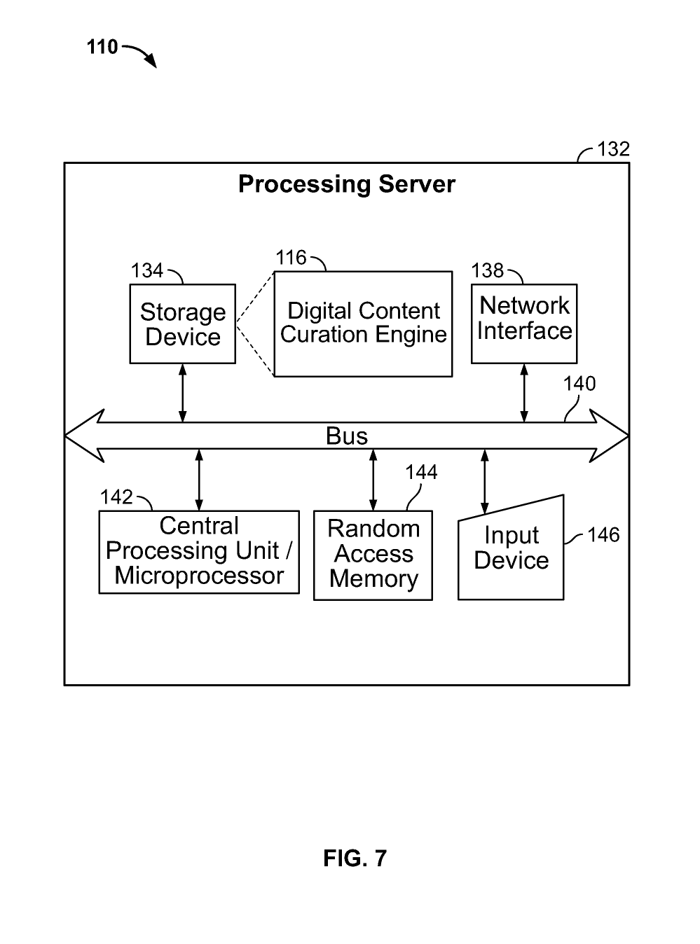

FIG. 7 is a diagram showing in more detail hardware and software components of a computer system on which the digital content curation system 110 of the present disclosure could be implemented. The digital content curation system 110 comprises a processing server 132 which could include a storage device 134, a network interface 138, a communications bus 140, a central processing unit (CPU) (microprocessor) 142, a random access memory (RAM) 144, and one or more input devices 146, such as a keyboard, mouse, etc. The server 132 could also include a display (e.g., liquid crystal display (LCD), cathode ray tube (CRT), etc.). The storage device 134 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The server 132 could be a networked computer system, a personal computer, a smart phone, tablet computer etc. It is noted that the server 132 need not be a networked server, and indeed, could be a stand-alone computer system.

The functionality provided by the present disclosure could be provided by a digital content curation program/engine 116, which could be embodied as computer-readable program code stored on the storage device 134 and executed by the CPU 142 using any suitable, high or low level computing language, such as Python, PHP, Java, C, C++, C#, .NET, MATLAB, etc. The network interface 138 could include an Ethernet network interface device, a wireless network interface device, or any other suitable device which permits the server 132 to communicate via the network. The CPU 142 could include any suitable single- or multiple-core microprocessor of any suitable architecture that is capable of implementing and running the engine 116 (e.g., Intel processor). The random access memory 144 could include any suitable, high-speed, random access memory typical of most modern computers, such as dynamic RAM (DRAM), etc.

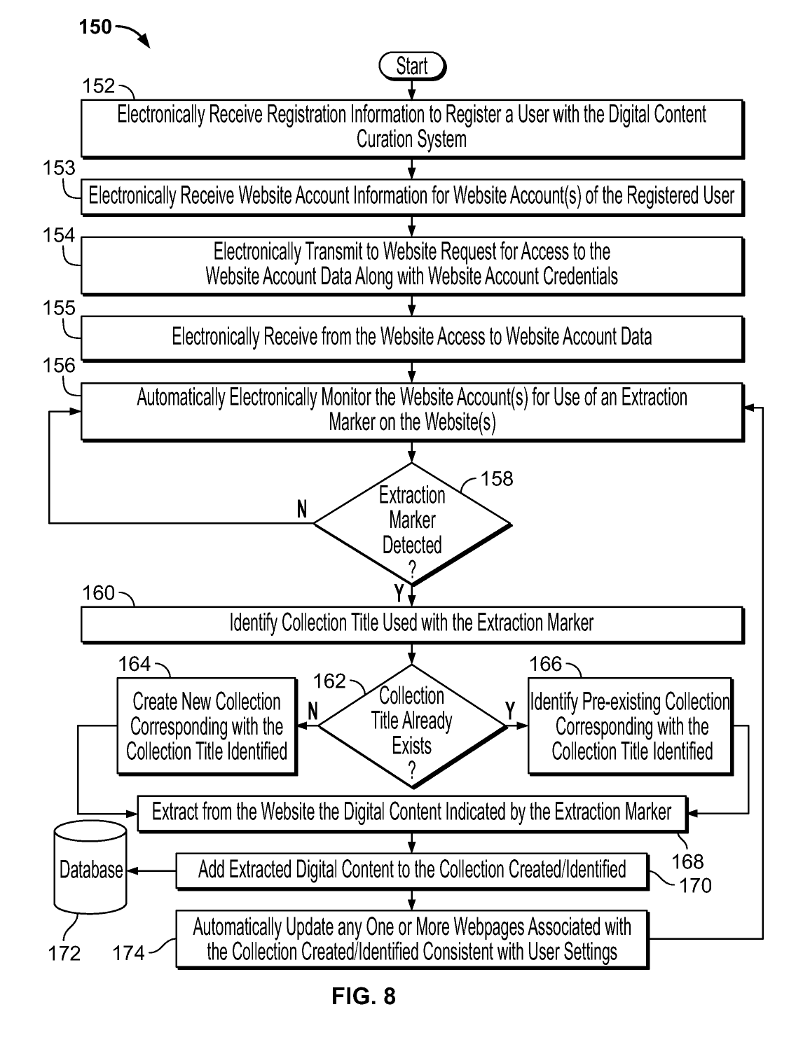

FIG. 8 illustrates processing steps 150 of the digital content curation system 110 of the present disclosure. The order of these processing steps are exemplary and could be executed in a different order. The steps are described in connection with a web site, but are more generally applicable to a digital content platform other than, and/or in addition to, a web site. In step 152, the digital content curation system 110 electronically receives registration information to register a user therewith. Registration information could include username, password, age, residential address, email address, phone number, etc. A user could sign into the digital content curation system 110 by downloading a mobile application to the user's smart cellular telephone 122b, accessing the web application via a web browser, etc.

Once a user is registered, for example, in step 153, the digital content curation system 110 electronically receives website account credentials for website account(s) of the registered user. The digital content curation system 110 could receive website account credentials from any website (and any type of website) with which the user has a registered account. For example, the digital content curation system 110 could receive website account credentials for a social network website (e.g., Twitter, Facebook, LinkedIn, Instagram, etc.), for a news reporting website (e.g., New York Times, Huffington Post, etc.), for a news aggregator website (e.g., Reddit), for an e-commerce store (e.g., Amazon), etc.

In step 154, the digital content curation system 110 electronically transmits to the website (e.g., Twitter) via a website API (e.g., via Twitter API) a request for access to website account data (e.g., Twitter account data) of the registered user, along with website account credentials (e.g., Twitter username and password). In step 155, the digital content curation system 110 electronically receives from a digital content platform, e.g., a website, access to account, e.g., website account, data (e.g., user data stream) of the registered user. Accordingly, the digital content curation registered account can be linked to one or more website accounts (or other digital content platforms) of the user.

In step 156, the digital content curation system 110 automatically electronically monitors (e.g., polls) the digital content platforms, e.g., website account(s) (e.g., website account data, user data stream, etc.) for use of an extraction marker (discussed in more detail below) on the website(s) by the registered user. More specifically, the digital content curation system 110 automatically electronically monitors (e.g., polls) activity (e.g., digital content) on one or more websites, and screens for an extraction marker (e.g., && or $$, etc.) in digital content (e.g., comments, posts, and other similar website activity) created by a linked website account. Example digital content could include comments, Youtube videos, Tweets, Vines, Instagram posts, Facebook posts, New York Time articles, etc.

In step 158, the digital content curation system 110 determines whether an extraction marker has been detected. If not, the process reverts to step 156. If an extraction marker has been detected, then in step 160, the digital content curation system 110 identifies a collection title used with the extraction marker as part of an extraction tag. An extraction tag (described in more detail below) comprises the extraction marker and collection title. Any unique extraction marker could be used, such as ##, **, ++, #$, ˜˜, [ ], #*, ̂, !!, CollectionTitle:, ###, CN, CN#, etc. In an exemplary list where the collection to be extracted to was titled CollectionName, some example extraction tags which use the example extraction markers previously described include ##CollectionName, **CollectionName, ++CollectionName, #$CollectionName, ˜˜CollectionName, [CollectionName], #*CollectionName, ̂CollectionName, !!CollectionName, CollectionTitle:CollectionName, ###CollectionName, CNCollectionName, CN#CollectionName, etc.

The extraction marker could be any type of extraction marker. More specifically, as described above, an example extraction tag is a two part string which includes an extraction marker and a collection title adjacent thereto. The extraction marker could be any suitable string, such as those listed in the above referenced exemplary list. The text/characters that are selected (e.g., by the programmer) to form the extraction marker are completely arbitrary, and any text/characters could be used as extraction marker (e.g., as set by the digital content curation system 110 and/or as set by the user), as long as the digital content curation system 110 monitors and filters for that particular extraction marker. In other words, the text/characters forming the extraction marker can be any text/characters so long it is those text/characters that are being monitored for.

In step 162, the digital content curation system 110 determines whether the collection title associated with the extraction tag already exists. If not, in step 164, the digital content curation system 110 creates a new collection corresponding with the collection title identified. If a collection title already exists, then in step 166 the digital content curation system 110 identifies the pre-existing collection corresponding to the collection title identified.

Either way, in step 168, the digital content curation system 110 extracts from the website, for example, the digital content indicated by (e.g., associated with, proximate to, etc.) the extraction marker. For example, the digital content curation system 110 could identify a reply comment with an extraction tag of a linked website account, which could indicate that the digital content curation system 110 should extract the digital content being replied to (discussed in more detail below). Step 168 could be executed before the collection title is identified in steps 162-166. In step 170, the digital content curation system 110 adds the extracted digital content to the collection created/identified by the digital content curation system 110. The extracted digital content and respective collections could be stored in a database 172 (e.g., datastore) in electrical communication with the digital content curation system 110.

In step 174, the digital content curation system 110 could automatically create/update (e.g., simultaneously) any one or more webpages (e.g., ticker, e-commerce store front, etc.) associated with the collection created/identified consistent with user settings. The digital content curation system 110 allows a user to share and/or embed the collection in webpages. Further, the digital content curation system 110 could create a webpage which has a URL address associated with the collection title and/or the username of the registered user (e.g., the collection title and/or username could be a part of the URL web address). For example, if a new collection title NewCategory is used in an extraction tag (e.g., &&NewCategory) by the registered user NewUser7, the digital content curation system 110 could create a new collection NewCategory with the extracted digital content and create a webpage with the extracted digital content with a URL of hashfav.com/NewUser7/NewCategory. Of course, a user could choose which, if any, collections to share by use of privacy settings. For example, a user could choose the privacy settings for a particular collection to be public, private, or shared with specific individuals, etc.

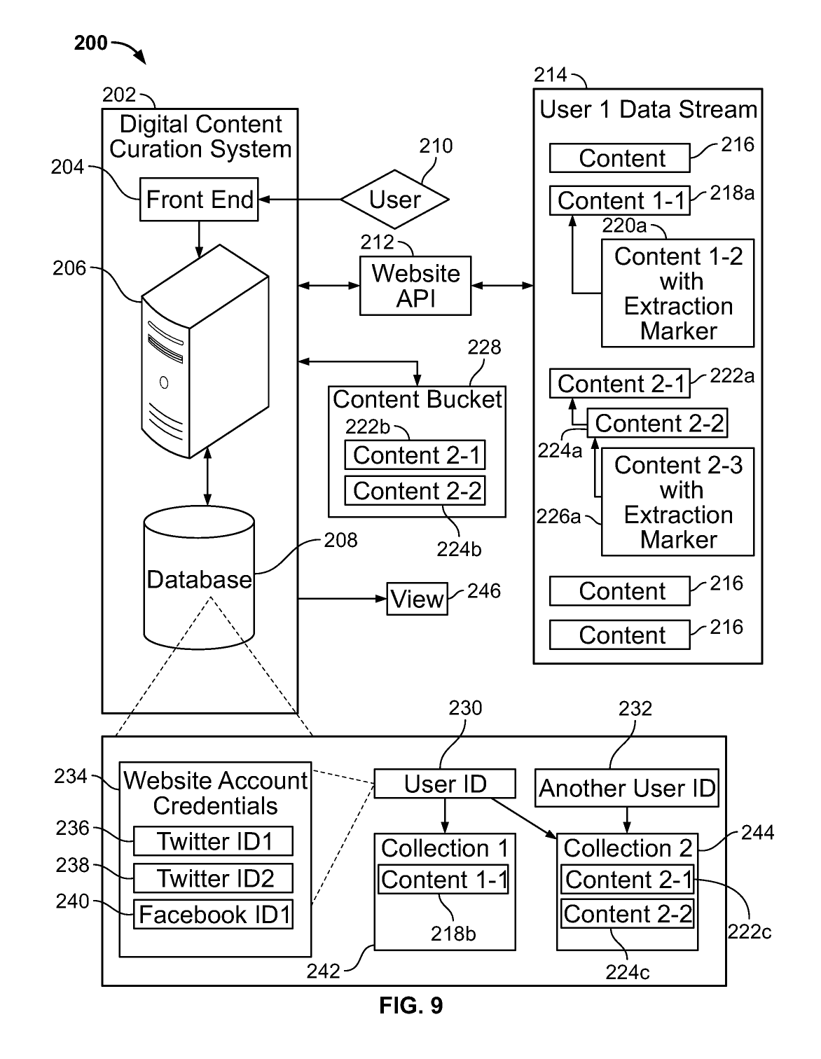

FIG. 9 is a diagram 200 further illustrating the digital content curation system 202. More specifically, the digital content curation system 202 includes a front end 204, a server 206, and a database 208, where the server 206 is in electrical communication with the front end 204 and the database 208. The front end 204 could be a website or mobile application (e.g., iOS, android, etc.), and could electronically communicate with one or more users (e.g., user 210) over a network (e.g., receiving registration information, etc.). The mobile application could be downloaded to a user's smart cellular telephone 122b. The database 208 could be a datastore or any type of database (e.g., post gres, etc.).

As described in FIG. 8 above, the front end 204 could electronically receive registration information from a user 210 (e.g., see step 152), such as via the smart cellular telephone 122b of the user 210. The front end 204 could communicate the registration information to the server 206 to create a new curation account (e.g., a new digital content curation system account) for the user, along with a unique user ID 230 to identify the user 210. This information could be stored in database 208. The front end 204 could also receive (e.g., via the smart cellular telephone 122b of the user 210) website account credentials 234 (e.g., website account ID, password, etc.), and communicate the website account credentials to the server 206 to associate the website account credentials with the user ID 230 (e.g., see step 153). Each user ID 230 could be associated with one or more website account credentials 234, even if the website account credentials 234 are from the same and/or different websites. In other words the user ID 230 could be associated with one or more website accounts of one or more different websites (e.g., Tumblr ID, Facebook ID, Twitter ID, Youtube ID, New York Times ID, Amazon ID, etc.), or with multiple accounts of the same website (e.g., @ronak, @ronak2, etc.). For example, a user ID 230 could be associated with a first Twitter account (e.g., Twitter ID1 236), a second Twitter account (e.g., Twitter ID2 238), and/or a Facebook account (e.g., Facebook ID1 240).

FIG. 9 also shows a number of other components which are described in more detail below. For example, FIG. 9 shows a website API 212 which facilitates communication between the digital content curation system 202 and another digital content platform (e.g., another website), and a user data stream 214 including digital contents 216, 218a, 220a, 222a, 224a, 226a, wherein some of the digital contents are associated with an extraction marker and others are not associated with an extraction marker. FIG. 9 also shows a content bucket 228 which could store (e.g., temporarily) digital contents (e.g., content 2-1 222b, content 2-2 224b) during the extraction process. FIG. 9 shows a user ID 230 and another user ID 232 and their respective access to collection 1 242 (associated with extracted content 1-1 218b) and collection 2 244 (associated with extracted content 2-1 222c and extracted content 2-2 224c). FIG. 9 further shows a view 246 associated with a resource identifier (e.g., website URL) for public and/or private access (e.g., via the Internet) of extracted digital contents.

The front end 204 could electronically transmit to the website over the network a request for access to account data, e.g., website account data, along with website account credentials (e.g., see step 154). The request could be transmitted via a website application program interface (API) 212, such as Twitter API. The front end 204 could electronically receive from the website access to website account data, such as a user data stream 214 (e.g., see step 155). The user data stream 214 could comprise all activity (e.g., digital content) associated with a user account (e.g., created by a user) on a particular website. For example, the Twitter user data stream are all of the Tweets, Reply Tweets, etc. that are associated with a Twitter user account on the Twitter website.

Upon initial access to the website account, the digital content curation system 202 could extract digital content that has already been marked (e.g., favorite) by the user through the website platform, and automatically organize such content into one or more collections. For example, prior to using the digital content curation system 202, a user may have marked as a favorite one or more tweets using the Twitter website platform. The digital content curation system 202 could extract the marked content and store in a collection named “uncategorized favorites.”

Once the account is linked, for example, the digital content curation system 202 monitors (e.g., by an authenticated HTTP request) a user data stream 214 of digital content (e.g., tweets, replies, favorites, unfavorites, etc.) of the user 210 via the website API 212 (e.g., see step 156). The user data stream 214 could be continuous or intermittent. For example, requests by the digital content curation system 202 for updates to the user data stream 214 of digital content could be made to the website API at regular intervals (e.g., every minute, five minutes, hour, etc.).

The user data stream 214 could comprise all digital contents associated with a website account (e.g., such as those made by a user 210 via a smart cellular telephone 122b), including digital contents without an extraction marker 216, and digital contents associated with an extraction marker 220a, 226a. The user data stream 214 could include digital contents which are part of a thread. For example, a post (e.g., digital content) could be a reply to a parent post, such that the reply and the parent post are part of the same thread. As another example, a post (e.g., digital content) could be a reply to a parent post, which is a reply to a grandparent post, such that the reply, parent post, and grandparent post are part of the same thread.

When the digital content curation system 202 identifies digital content with an extraction marker 220a, 226a (e.g., see step 158), the digital content curation system 202 polls the data string, parses the extraction tag, extracts the associated digital content, and at least temporarily stores the extracted digital content in a content bucket 228. More specifically, when digital content with an extraction marker (e.g., marked digital content) is identified, for example, the digital content curation system 202 then identifies the parent digital content the marked digital content was a reply to (e.g., in Twitter each tweet contains a Boolean describing whether the tweet is a reply to another tweet and, if so, the tweet ID that it was a reply to). The digital content curation system 202 extracts the parent digital content and temporarily stores it in a content bucket 228 (e.g., see step 168).

The digital content curation system 202 checks if the parent digital content was itself a reply to another parent digital content (e.g., grandfather digital content). If not, the digital content curation system 202 exports the content bucket to add the extracted parent digital content to the collection identified in the extraction marker. Otherwise, the digital content curation system 202 identifies the grandfather digital content, extracts the grandfather digital content and temporarily stores the grandfather digital content in a content bucket 228. This continues up the thread until the end of the thread (e.g., the original digital content) is reached. The digital content curation system 202 exports the content bucket to add the extracted digital content thread to the collection identified in the extraction marker. Of course, settings could be provided for the user such that only the digital content immediately replied to is extracted (e.g., extract only the parent digital content), or limit how much digital content can be extracted for any single use of an extraction marker (e.g., extract the parent digital content and grandfather digital content), etc.

For example, as shown, the digital content curation system 202 could identify content 1-2 with extraction marker 220a (e.g., content 1-2). The digital content curation system 202 parses the extraction tag of content 1-2 220a to obtain the ID of content 1-1 218a (to which content 1-2 was a reply), and extracts content 1-1 218a to content bucket 228. The digital content curation system 202 checks if content 1-1 218a is itself a reply to another digital content.

As another example, as also shown, the digital content curation system 202 could identify content 2-3 with extraction marker 226a (e.g., content 2-3). The digital content curation system 202 processes content 2-3 226a to obtain the ID of content 2-2 224a (to which content 2-3 was a reply), and extracts content 2-2 224a to content bucket 228. The digital content curation system 202 checks if content 2-2 224a is itself a reply to another digital content. The digital content curation system 202 processes content 2-2 224a to obtain the ID of content 2-1 222a (to which content 2-2 was a reply), and extracts content 2-1 222a to content bucket 228. The digital content curation system 202 checks if content 2-1 222a is itself a reply to another digital content.

If the digital content curation system 202 identifies digital content with an extraction marker, but does not identify such content as a reply (e.g., unable to identify original content), the digital content curation system 202 extracts the digital content with an extraction marker and temporarily stores it in the content bucket 228. For example, if a standalone tweet contains an extraction marker (and is not a reply to another tweet), the digital content curation system 202 would extract the standalone tweet itself.

Once the digital content curation system 202 has extracted all of the digital content associated with the extraction marker to the content bucket (consistent with the user settings), for example, the extracted digital contents of the content bucket are exported to the collection identified in the extraction tag (e.g., see step 156), where the collection identified is a preexisting collection or a collection to be newly created by the digital content curation system 202. The content bucket 228 has a website account ID (e.g., Twitter ID, Facebook ID, etc.) associated with the marked digital content, as well as the extraction tag thereof (e.g., the extraction marker and collection title) (e.g., see step 160). The digital content curation system 202 retrieves the website account ID from the content bucket and queries the database 208 for the user ID with the matching website account ID. The digital content curation system 202 requests the collections associated with the user ID, and checks if any of the collections associated with the user ID match the collection title identified in the extraction marker (e.g., see step 162).

In this way, the digital content curation system 202 checks if the collection title has been used before for the associated user ID, and if so adds the extracted digital content to that collection (e.g., see step 166 and 170). Otherwise, if the collection title has not yet been created, the digital content curation system 202 creates a new collection for that user and adds the extracted digital content thereto (e.g., see steps 164 and 170). For example, content 2-2 224b and content 2-1 222b of content bucket 228 (which were extracted from content 2-2 224a and content 2-1 222a from user data stream 214) could be added to collection 2 244 as content 2-1 222c and content 2-2 224c. Alternatively, the content bucket 228 could be omitted completely, such that content is extracted directly into the collection. For example, content 1-1 218 from the user data stream 214 could be added to collection 1 242 as content 1-1 218b.

Accordingly, a user can curate digital content to one or more collections from one or more website account IDs (e.g., Twitter ID1 236, Twitter ID2 238, etc.). Further, one or more users (e.g., more than one user ID) can curate digital content to the same collection. For example, a first user associated with user ID 230 and a second user associated with another user ID 232 could both update collection 2 244. Further, the user could curate (e.g., add, remove, move, etc.) digital content within one or more collections from a website without having to leave the website.

The digital content curation system 202 could update a view 246, such as a webpage (e.g., www.hashfav.com/UserName/CollectionName) or a client (e.g., see step 174). The view 246 could be updated by pulling the relevant digital content (e.g., of the collection associated with the view 246) whenever the view is accessed and/or pushing the relevant digital content whenever the database is updated (e.g., whenever a relevant collection associated with the view 246 is updated) consistent with the user settings (e.g., user privacy settings).

The digital content curation system 202 could be a platform integrated with or separate from the website platform. For example, if the digital content curation system 202 is integrated with the website platform, the digital content curation system could communicate without an API or monitor a user data stream. For example, if the digital content curation system 202 was integrated with Twitter, when a user posts a tweet, the Twitter platform could initiate a function that looks for the extraction marker within the Tweet. If the Twitter platform identifies the extraction marker (and/or associated extraction tag), the Twitter platform could proceed similarly to that described above.

As another alternative, the digital content curation system 202 could monitor the digital content of all users of a website. In this case, when an extraction marker (and/or extraction tag) is identified in a digital content, the digital content curation system 202 could proceed similarly to that described above. This could be implemented on a third party website if the digital content curation system 202 has appropriate access to the third party website, or this could be integrated into the website platform itself (e.g., without separate user registration).

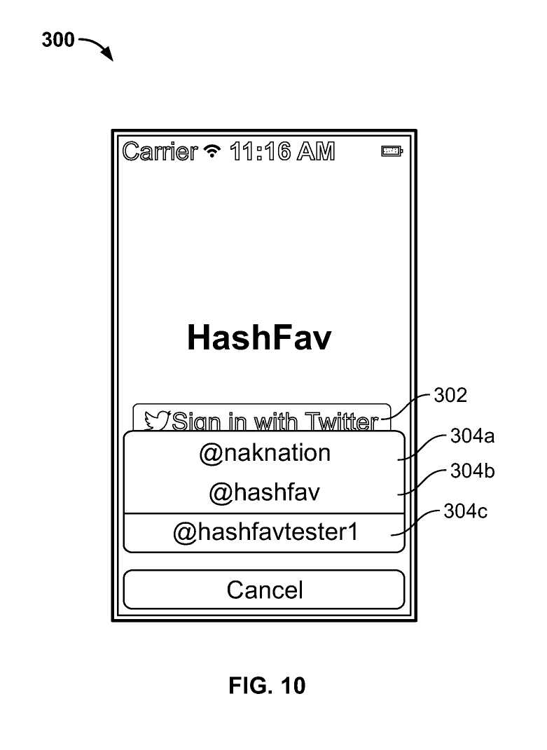

FIGS. 10-14 are screenshots illustrating example use of the digital content curation system using a mobile device. More specifically, FIG. 10 is a screenshot of a sign-in page 300 of the digital content curation system. The sign-in page 300 allows a user to sign-in to the digital content curation system via the sign-in button 302 using the website account ID of a third party website. For example, a user could sign-in to the digital content curation system using one or more Twitter IDs.

To expedite sign-in, the digital content curation system could save and display website account IDs and/or curation account IDs that have been previously used to sign into the digital content curation system and/or that are linked with the digital content curation system. For example, upon receiving input from the user clicking the sign-in button 302, the digital content curation system could display a submenu of several Twitter accounts 304a, 304b, 304c, thereby providing the user with a chance to elect one of them (e.g., by clicking).

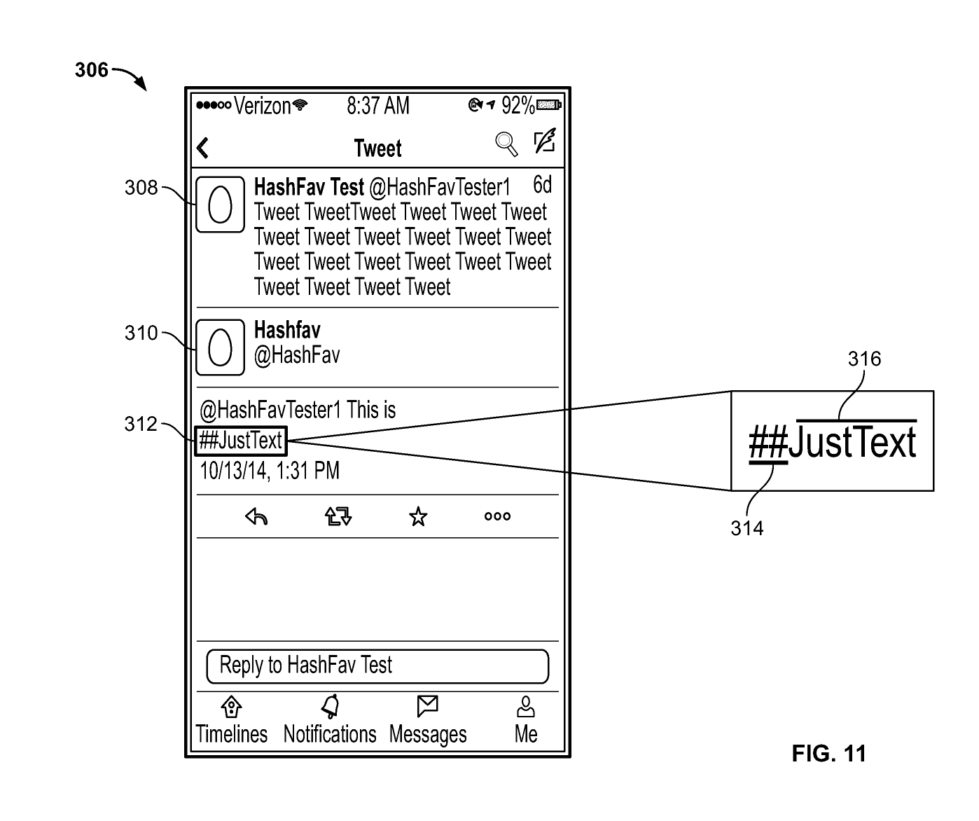

FIG. 11 is a screenshot 306 of an application with digital content 308 to be curated. To curate the digital content 308 the user replies with reply digital content 310, the reply digital content 310 including extraction tag 312. The extraction tag 312 includes the extraction marker 314 (e.g., ##) and collection title 316 (e.g., JustText). The extraction marker 314 indicates that the user would like to curate content, the collection title 316 indicates the collection the user would like to extract the digital content to, and the parent digital content 308 (associated with the reply digital content 310) is the content the user would like to extract. As indicated above, the extraction marker could be any type of extraction marker (e.g., any suitable string of text/characters). The text/characters of the extraction marker is arbitrarily defined—any text/characters could be used for the extraction marker—so long as the digital content curation system 110 monitors and filters for that particular extraction marker (e.g., that particular text/characters).

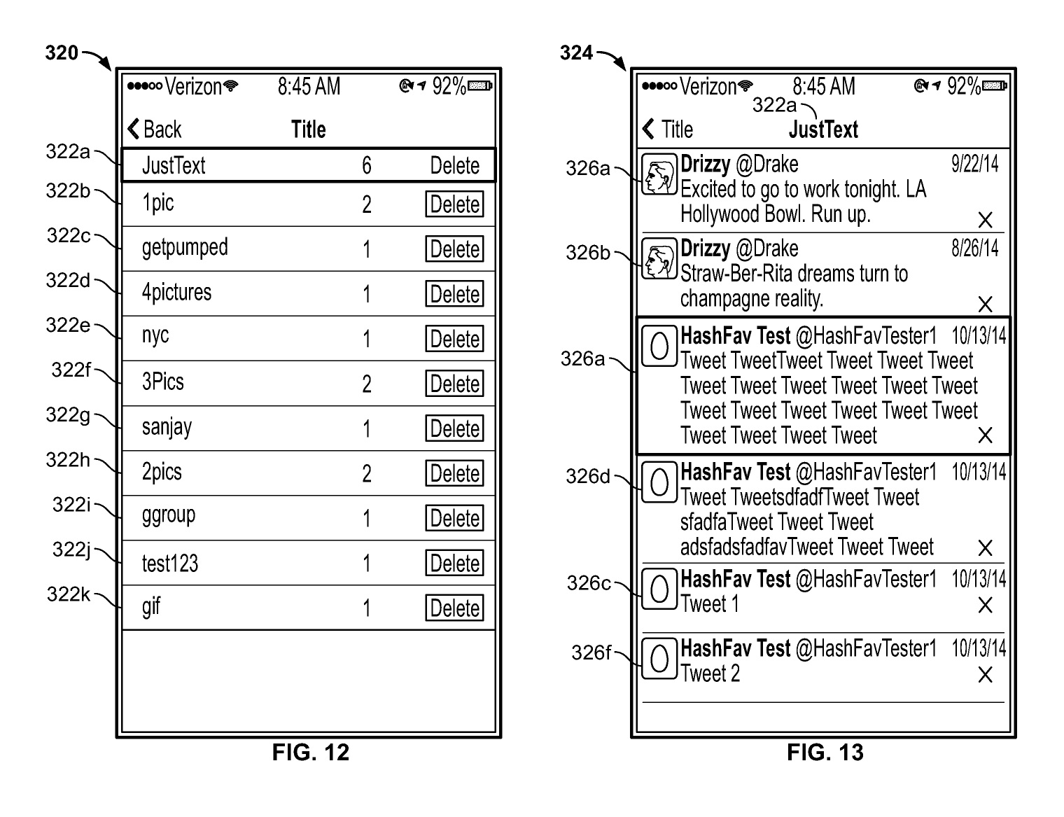

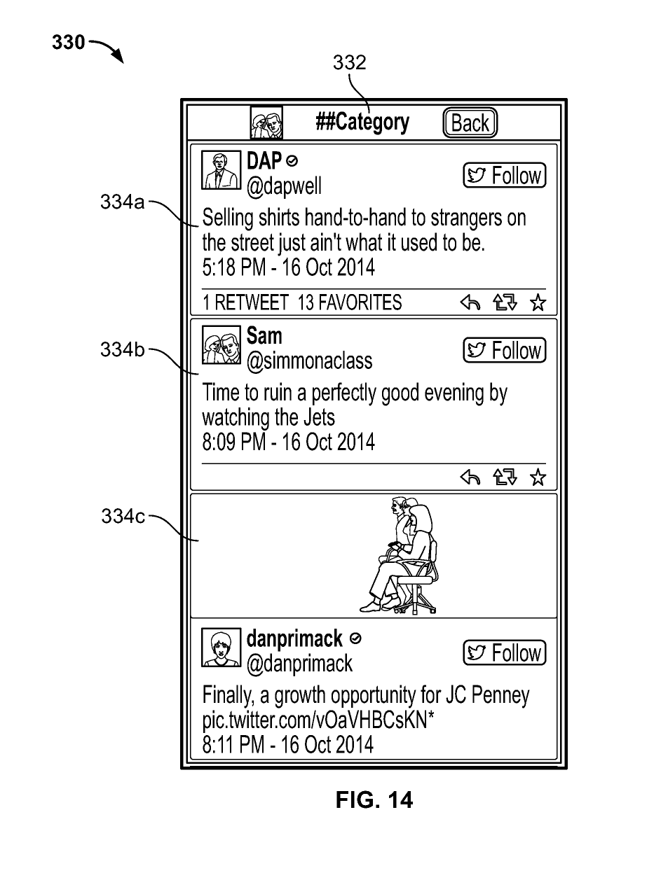

FIG. 12 is a screenshot 320 of different collections 322a-322k associated with a particular user account of the digital content curation system. FIG. 13 is a screenshot 324 of digital contents 326a-326f stored in a particular collection 322a (e.g., JustText). FIG. 14 is a screenshot 330 of a webpage of one of the collections created by a user. More specifically, the extracted digital contents 334a-334c stored under the collection title ##Category are displayed on a webpage (or otherwise publicly or selectively viewable by other users). Accordingly, when the user curates additional digital content to this collection, the associated webpage will update with the newly curated digital content.

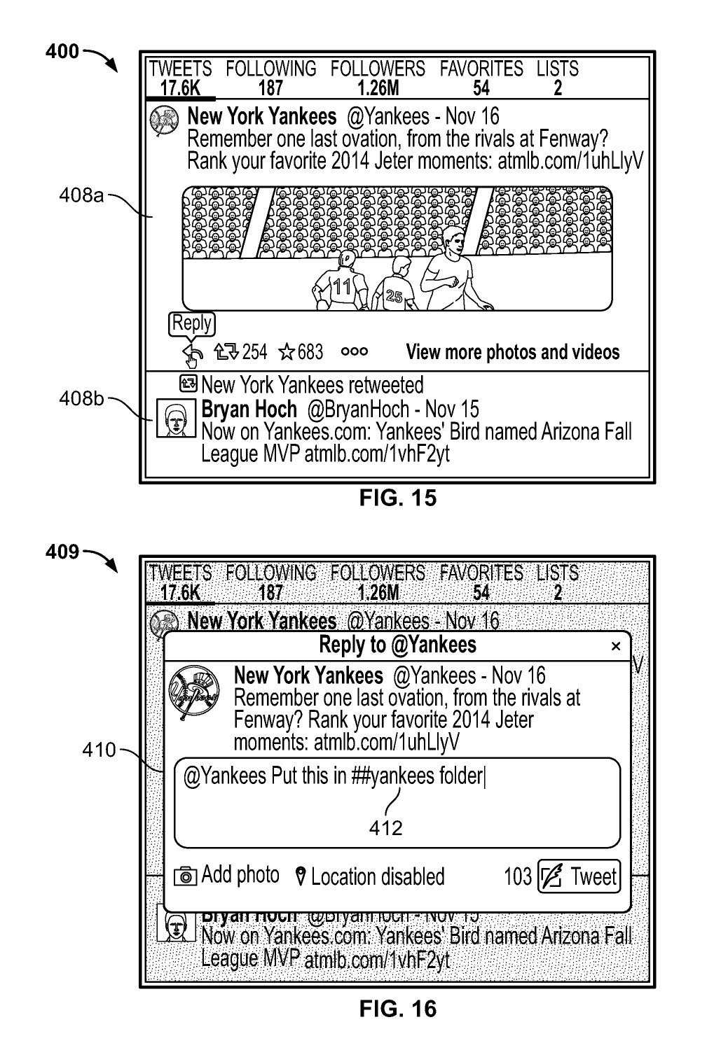

FIGS. 15-19 are screenshots illustrating use of the digital content curation system using a computer browser. More specifically, FIG. 15 is a screenshot 400 of a first digital content 408a (e.g., a first Tweet) and a second digital content 408b (e.g., a second Tweet) on a website (e.g., Twitter). FIG. 16 is a screenshot 409 of a user reply 410 to the first digital content 408a which the user would like to curate. Within the user reply 410, the user includes the extraction marker ##yankees. Accordingly, the digital content curation system parses the text of the reply to identify the extraction marker ## and the collection title Yankees the user would like to curate the digital content to. The digital content curation system identifies and parses the extraction marker, and extracts the parent digital content.

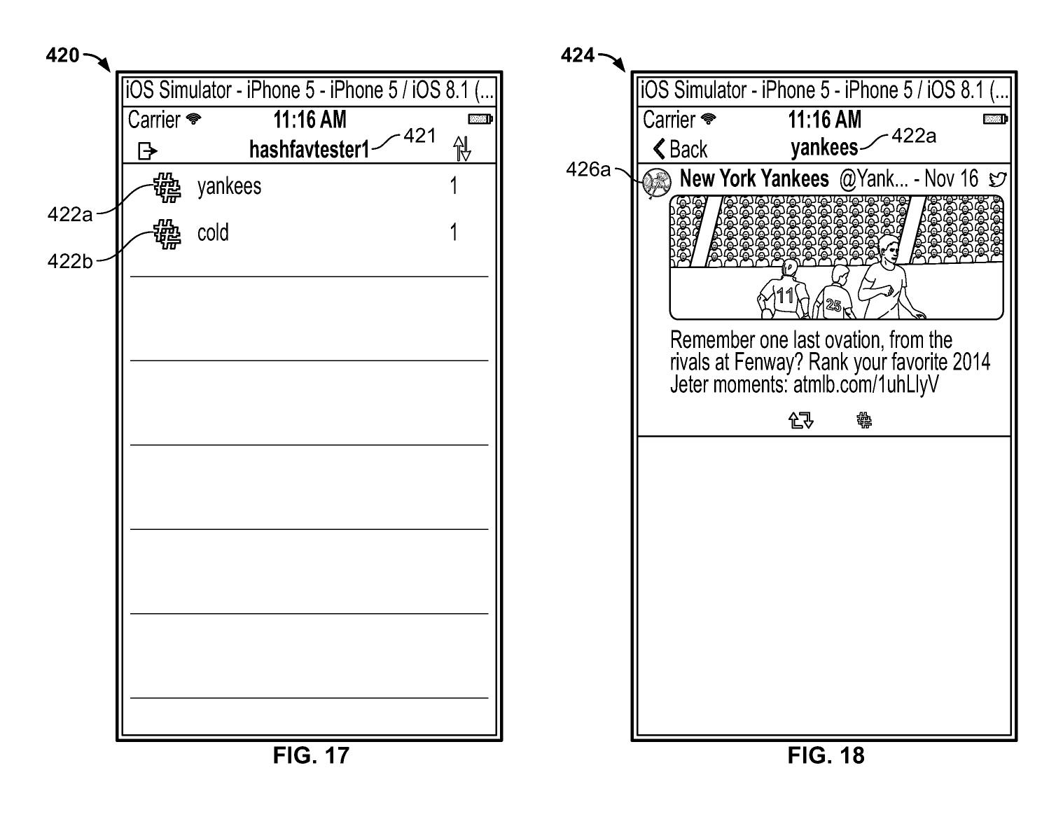

FIG. 17 is a screenshot 420 of collections associated with user ID hashfavtester1 of the digital content curation system. More specifically, the user ID hashfavtester1 includes a collection title yankees 422a and collection title cold 422b. FIG. 18 is a screenshot 424 of extracted digital content 426a (as also shown in FIGS. 15-16) associated with the collection title yankees 422a.

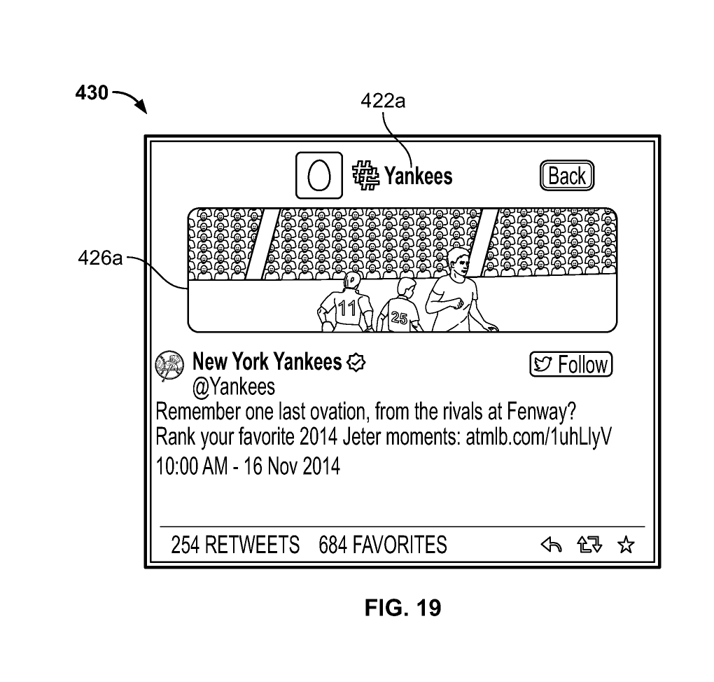

FIG. 19 is a screenshot 430 of a webpage of one of the collections created by a user.

More specifically, the extracted digital content 426a stored under the collection title ##yankees 422a are displayed on a webpage (or otherwise publicly or selectively viewable by other users). Accordingly, when the user curates additional digital content to this collection, the associated webpage will update with the newly curated digital content.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

1. A method for curating digital content comprising:
electronically receiving, at a digital content curation system, registration information to register a user therewith;
electronically receiving, at the digital content curation system, website account credentials for a website account of a website;
electronically transmitting, by the digital content curation system to the website, a request for access to website account data, along with the website account credentials;
electronically automatically monitoring, by the digital content curation system, website account data for an extraction marker of an extraction tag;
automatically detecting, by the digital content curation system, the extraction marker of the extraction tag in marked digital content created by the website account;
automatically identifying, by the digital content curation system, a collection title of the extraction tag adjacent to the extraction marker;
electronically extracting, by the digital content curation system, parent digital content indicated by the extraction marker of the marked digital content; and
electronically adding to a database, by the digital content curation system, the parent digital content extracted to a collection having the collection title identified.

2. The method of claim 1, further comprising determining whether the collection title identified already exists in the database.

3. The method of claim 2, wherein if the collection title does not already exist, the digital content curation system automatically creates a new collection corresponding to the collection title identified.

4. The method of claim 3, further comprising automatically creating a webpage associated with the new collection.

5. The method of claim 2, wherein if the collection title already exists, the digital content curation system identifies the pre-existing collection corresponding to the collection title identified.

6. The method of claim 5, further comprising automatically updating a webpage associated with the pre-existing collection.

7. The method of claim 1, wherein the step of electronically extracting parent digital content includes extraction of a thread of parent digital content associated with the marked digital content.

8. A method for curating digital content comprising:
electronically receiving, at a digital content curation system, registration information to register a user therewith;
electronically receiving, at the digital content curation system, digital content platform account credentials for a digital content platform account of a digital content platform;
electronically transmitting, by the digital content curation system to the digital content platform, a request for access to digital content platform account data, along with the digital content platform account credentials;
electronically automatically monitoring, by the digital content curation system, digital content platform account data for an extraction marker of an extraction tag;
automatically detecting, by the digital content curation system, the extraction marker of the extraction tag in marked digital content created by the digital content platform account;
automatically identifying, by the digital content curation system, a collection title of the extraction tag adjacent to the extraction marker;
electronically extracting, by the digital content curation system, parent digital content indicated by the extraction marker of the marked digital content; and
electronically adding to a database, by the digital content curation system, the parent digital content extracted to a collection having the collection title identified.

9. The method of claim 8, further comprising determining whether the collection title identified already exists in the database.

10. The method of claim 9, wherein if the collection title does not already exist, the digital content curation system automatically creates a new collection corresponding to the collection title identified.

11. The method of claim 10, further comprising automatically creating a webpage associated with the new collection.

12. The method of claim 9, wherein if the collection title already exists, the digital content curation system identifies the pre-existing collection corresponding to the collection title identified.

13. The method of claim 12, further comprising automatically updating a webpage associated with the pre-existing collection.

14. The method of claim 8, wherein the step of electronically extracting parent digital content includes extraction of a thread of parent digital content associated with the marked digital content.
